(19) United States
(12) Patent Application Publication
(10) Pub. No.: US 2014/0306943 A1
(43) Pub. Date: Oct. 16, 2014

(54) ELECTRONIC DEVICE AND METHOD FOR ADJUSTING BACKLIGHT OF ELECTRONIC DEVICE

(71) Applicant: FIH (Hong Kong) Limited, Kowloon (HK)

(72) Inventor: SAN-HSIN KUO, New Taipei (TW)

(73) Assignee: FIH (HONG KONG) LIMITED, Kowloon (HK)

(21) Appl. No.: 14/252,735

(22) Filed: Apr. 14, 2014

(30) Foreign Application Priority Data
Apr. 16, 2013 (TW) 102113504

(51) Int. Cl. G09G 5/10

(52) U.S. Cl. CPC G09G 5/10
USPC 345/207

(57) ABSTRACT

In a method for adjusting brightness of a backlight of an electronic device, an association between ambient light intensity of the electronic device and brightness of the backlight is established. An image in front of the electronic device is captured. A current ambient light intensity of the electronic device is calculated according to the image, and a corresponding brightness of the backlight is determined. The backlight is controlled to emit light with the determined brightness.

### BACKGROUND

1. Technical Field

The embodiments of the present disclosure relate to systems and methods for light control, and particularly to an electronic device and a method for adjusting backlight of the electronic device.

2. Description of Related Art

Backlight brightness of an electronic device can be adjusted using light sensors to provide preferable lighting effects. If the electronic device is not equipped with any light sensor, the backlight brightness has to be adjusted manually, which may cause inconvenience to users.

### BRIEF DESCRIPTION OF THE DRAWINGS

FIG. 1 is one embodiment of an electronic device.

FIG. 2 is a block diagram of one embodiment of function modules of a backlight adjustment system of the electronic device in FIG. 1.

FIG. 3 is a flowchart of one embodiment of a method for adjusting brightness of a backlight of the electronic device of FIG. 1.

FIG. 4 is one embodiment illustrating an association between ambient light intensity of an electronic device and brightness of a backlight of the electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives.

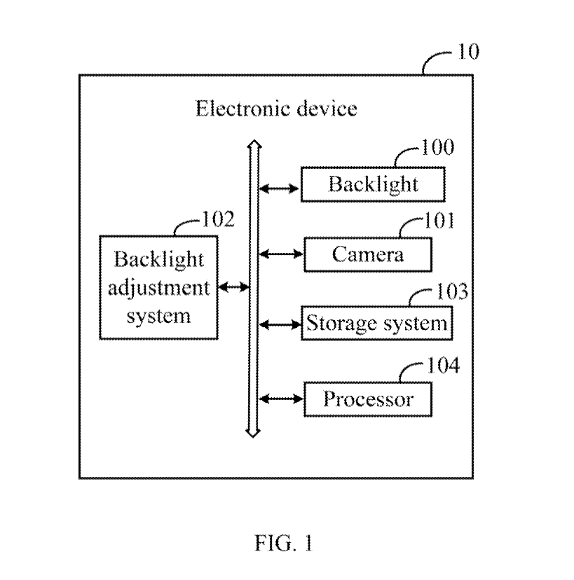

FIG. 1 is one embodiment of an electronic device 10. The electronic device 10 includes a backlight 100, a camera 101, and a backlight adjustment system 102. The backlight 100 may be a screen backlight for backlighting a display screen of the electronic device 10, or a keyboard backlight for backlighting a keyboard of the electronic device 10. The camera 101 may be a front facing camera, which captures images in front of the electronic device 10. The backlight adjustment system 102 adjusts brightness of the backlight 100 automatically according to ambient light intensity of the electronic device 10, without any light sensors installed in the electronic device 10. The electronic device 10 may be a mobile device, such as a mobile phone, a play station portable (PSP), or a tablet computer. FIG. 1 is only one example of the electronic device 10, and other examples may comprise more or fewer components than those shown in the embodiment, or have a different configuration of the various components.

The electronic device 10 may further include a storage system 103 and at least one processor 104. The storage system 103 can be a dedicated memory, such as EPROM, a hard disk drive (HDD), or flash memory. In some embodiments, the storage system 103 can also be an external storage device, such as an external hard disk, a storage card, or other data storage medium. The at least one processor 104 can be a central processing unit (CPU), a microprocessor, or other suitable data processor chip that performs various functions of the electronic device 10.

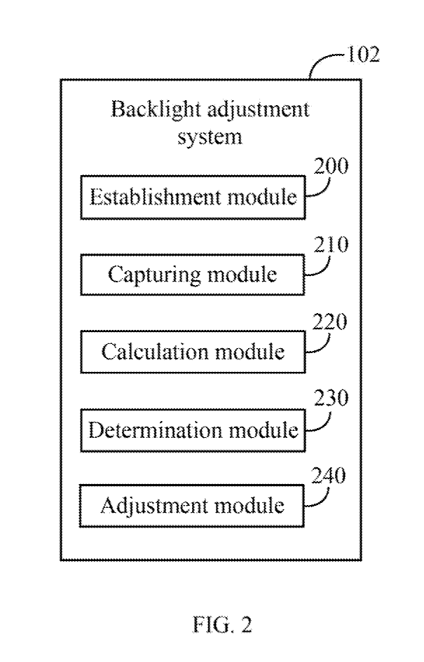

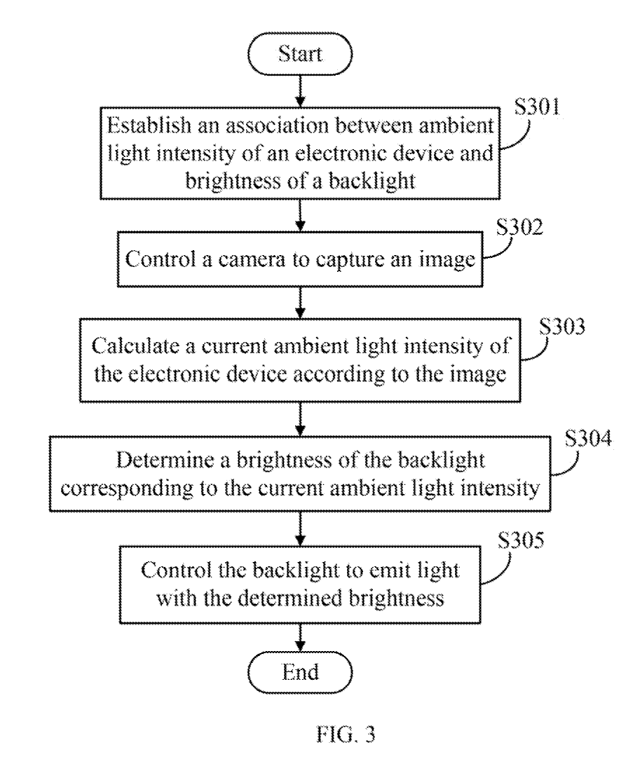

FIG. 2 is a block diagram of one embodiment of function modules of the backlight adjustment system 102 shown in FIG. 1. The backlight adjustment system 102 includes an establishment module 200, a capturing module 210, a calculation module 220, a determination module 230, and an adjustment module 240. The modules 200-240 may comprise computerized codes in the form of one or more computer-readable programs that are stored in a non-transitory computer-readable medium, such as the storage system 103. The computerized codes include instructions that are executed by the at least one processor 104, to provide the aforementioned functions of the backlight adjustment system 102. A detailed description of the functions of the modules 200-240 is given below in reference to FIG. 3.

FIG. 3 is a flowchart of one embodiment of a method for adjusting brightness of the backlight 100 of the electronic device 10 of FIG. 1. Depending on the embodiment, additional steps may be added, others removed, and the ordering of the steps may be changed.

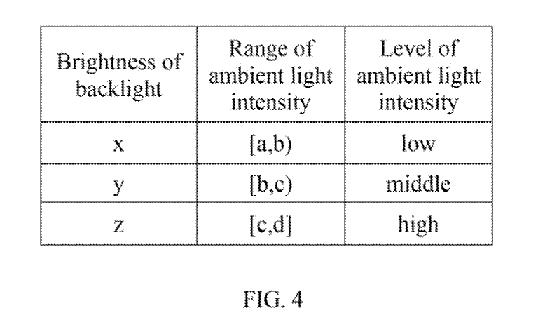

In step S301, the establishment module 200 establishes an association between ambient light intensity of the electronic device 10 and brightness of the backlight 100, and stores the association into the storage system 103. According to the association, a brightness of the backlight 100 corresponding to a given ambient light intensity (or a given ambient light intensity range) of the electronic device 10 is determined. FIG. 4 is one embodiment illustrating the association between the ambient light intensity of the electronic device 10 and the brightness of the backlight 100. In this embodiment, three ranges of the ambient light intensity of the electronic device 10 are preset. Each range of the ambient light intensity of the electronic device 10 corresponds to a certain brightness of the backlight 100.

In step S302, the capturing module 210 controls the camera 10 to capture an image in front of the electronic device 10. In one embodiment, the image is an RGB (red, green, and blue) image. Each pixel of the RGB image includes a red component value, a green component value, and a blue component value. The capturing module 210 may control the camera 10 to capture the image at a predetermined frequency, such as every ten seconds.

In step S303, the calculation module 220 calculates a current ambient light intensity of the electronic device 10 according to the image. In one embodiment, the calculation module 220 calculates a lightness value of each pixel of the image, and calculates the current ambient light intensity of the electronic device 10 according to the lightness value of each pixel of the image. For example, the calculation module 230 calculates an arithmetic mean of lightness values of pixels in the image as the current ambient light intensity of the electronic device 10.

In one embodiment, the image is an RGB image. The calculation module 220 calculates the lightness value of each pixel of the RGB image using a conversion formula. The conversion formula may be as follows: lightness value=(Max+Min)/2, wherein “Max” represents the maximum of the red component value, the green component value, and the blue component value of a pixel of the RGB image, and “Min” represents the minimum of the red component value, the green component value, and the blue component value of the pixel of the RGB image.

In step S304, the determination module 230 determines a brightness of the backlight 100 corresponding to the current ambient light intensity of the electronic device 10 according to the association between the ambient light intensity of the electronic device 10 and the brightness of the backlight 100. In one example with respect to FIG. 4, if the current ambient light intensity falls into a range of the ambient light intensity ranging from a value “a” to a value “b,” a brightness “x” of the backlight 100 is determined.

In step S305, the adjustment module 240 controls the backlight 100 to emit light with the determined brightness. The adjustment module 240 may generate a brightness signal according to the determined brightness of the backlight 100 and send the brightness signal to the backlight 100. The backlight 100 emits light with the determined brightness, driven by the brightness signal,.

Although certain disclosed embodiments of the present disclosure have been specifically described, the present disclosure is not to be construed as being limited thereto.

Various changes or modifications may be made to the present disclosure without departing from the scope and spirit of the present disclosure.

What is claimed is:

1. A method for adjusting brightness of a backlight of an electronic device, the method comprising:
establishing an association between ambient light intensity of the electronic device and brightness of the backlight;
controlling a camera installed in the electronic device to capture an image in front of the electronic device;
calculating a current ambient light intensity of the electronic device according to the image;
determining a brightness of the backlight corresponding to the current ambient light intensity of the electronic device according to the association between the ambient light intensity of the electronic device and the brightness of the backlight; and
controlling the backlight to emit light with the determined brightness.

2. The method of claim 1, wherein the current ambient light intensity of the electronic device is calculated by performing operations of:
calculating a lightness value of each pixel of the image; and
calculating the current ambient light intensity of the electronic device according to the lightness value of each pixel of the image.

3. The method of claim 2, wherein the current ambient light intensity of the electronic device is calculated by calculating an arithmetic mean of lightness values of pixels in the image.

4. The method of claim 1, wherein the backlight is a screen backlight for backlighting a display screen of the electronic device, or a keyboard backlight for backlighting a keyboard of the electronic device.

5. An electronic device, comprising:
a backlight;
a camera;
at least one processor; and
a storage system storing a computer-readable program comprising a plurality of instructions, which when executed by the at least one processor, causes the at least one processor to:
establish an association between ambient light intensity of the electronic device and brightness of the backlight;
control the camera to capture an image in front of the electronic device;
calculate a current ambient light intensity of the electronic device according to the image;
determine a brightness of the backlight corresponding to the current ambient light intensity of the electronic device according to the association between the ambient light intensity of the electronic device and the brightness of the backlight; and
control the backlight to light with the determined brightness.

6. The electronic device of claim 5, wherein the current ambient light intensity of the electronic device is calculated by performing operations of:
calculating a lightness value of each pixel of the image; and
calculating the current ambient light intensity of the electronic device according to the lightness value of each pixel of the image.

7. The electronic device of claim 6, wherein the current ambient light intensity of the electronic device is calculated by calculating an arithmetic mean of lightness values of pixels in the image.

8. The electronic device of claim 5, wherein the backlight is a screen backlight for backlighting a display screen of the electronic device, or a keyboard backlight for backlighting a keyboard of the electronic device.

9. A non-transitory computer-readable storage medium storing a set of instructions, the set of instructions capable of being executed by a processor of an electronic device to implement a method for adjusting brightness of a backlight of the electronic device, the method comprising:
establishing an association between ambient light intensity of the electronic device and brightness of the backlight;
controlling a camera installed in the electronic device to capture an image;
calculating a current ambient light intensity of the electronic device according to the image;
determining a brightness of the backlight corresponding to the current ambient light intensity of the electronic device according to the association between the ambient light intensity of the electronic device and the brightness of the backlight; and
controlling the backlight to emit light with the determined brightness.

10. The storage medium of claim 9, wherein the current ambient light intensity of the electronic device is calculated as follows:
calculating a lightness value of each pixel of the image; and
calculating the current ambient light intensity of the electronic device according to the lightness value of each pixel of the image.

11. The storage medium of claim 10, wherein the current ambient light intensity of the electronic device is calculated by calculating an arithmetic mean of lightness values of pixels in the image.

12. The storage medium of claim 9, wherein the backlight is a screen backlight for backlighting a display screen of the electronic device, or a keyboard backlight for backlighting a keyboard of the electronic device.
